(19) United States
(12) Patent Application Publication
(10) Pub. No.: US 2012/0293623 A1
(43) Pub. Date: Nov. 22, 2012

(54) METHOD AND SYSTEM FOR INSPECTING SMALL MANUFACTURED OBJECTS AT A PLURALITY OF INSPECTION STATIONS AND SORTING THE INSPECTED OBJECTS

(75) Inventor: Michael G. Nygaard, Fenton, MI (US)

(73) Assignee: GII ACQUISITION, LLC DBA GENERAL INSPECTION, LLC, Davisburg, MI (US)

(21) Appl. No.: 13/109,393

(22) Filed: May 17, 2011

(51) Int. Cl. H04N 7/18; H04N 13/02

(52) U.S. Cl. 348/46; 348/92; 348/E07.085; 348/E13.074

(57) ABSTRACT

A method and system for inspecting small, manufactured objects at a plurality of inspection stations and sorting the inspected objects are provided. Coins, coin blanks, tablets or pills are fed from a centrifugal feeder and conveyed or transferred by a transfer subsystem. The objects are spaced at equal intervals during conveyance to provide a “metering effect” which allows the proper spacing between objects for inspection and rejection of defects. The inspection stations may include imaging assemblies in the form of conventional cameras and/or three-dimensional sensors such as triangulation or confocal sensors. The inspection stations may include a circumference vision station and/or an eddy current station. Circumferential defects (like in edge lettering) on coins or rim defects on pills can be detected at the circumference vision station by another imaging assembly. Metal chips, foreign metallic debris, etc. in or on the tablets/pills can be detected at the eddy current station.

### CROSS REFERENCE TO RELATED APPLICATION

This application is related to U.S. patent application entitled “Method and System for Optically Inspecting Parts” filed on the same day as this application and having Attorney Docket No. GINS 0149 PUS.

### TECHNICAL FIELD

This invention relates in general to the field of the non-contact inspection of small manufactured objects and sorting the inspected objects and, more particularly, to methods and systems for inspecting small manufactured objects, such as pharmaceutical tablets, pills, tokens, coins, medals, etc. and planchets for such tokens, coins, medals, etc.

### OVERVIEW

Traditional manual inspecting devices and techniques have been replaced to some extent by automated inspection methods and systems. However, such automated inspection methods and systems still have a number of shortcomings associated with them.

Rapid inspection of defects on and in a variety of small, mass-produced objects is a vital aspect in the manufacturing process, allowing for maintenance of a high level of quality and reliability in a number of industries. For example, traditionally, quality control in the pharmaceutical industry has related to the type, purity, and amount of tablet ingredients. However, quality also relates to defects which can be detected by visual inspection such as dirt, surface blemishes, and surface chips. Although many visual inspections can be performed by operators, manual inspection can be slow, expensive and subject to operator error. Also, many types of inspections cannot be done visually. Thus, automated inspection systems for quality control in the pharmaceutical industry are extremely important. The following U.S. patents are related to these types of systems: U.S. Pat. Nos. 5,085,510, 4,319,269; 4,354,602; 4,644,150, 4,757,382; 5,661,249; 3,709,598, 5,695,043, 6,741,731; and 6,079,284.

The making of medicinal tablets by compression of powders, dry or treated, is an old art and satisfactory machinery for making such tablets has long been available. FIGS. 1a and 1b illustrate such tablets. Rotary presses are commonly in use, in which powders or other materials that can be formed into tablets are placed into one of a plurality of generally cylindrical discs that are mounted within a rotary die holding turret. A pair of opposed cam operated punches compress the powder from both ends of each tablet forming die, and thereby compact the powder into an individual tablet. The rotary turret arrangement allows a plurality of punch and die sets to produce tablets continuously around the circular path followed by the rotary press by sequentially contacting an arrangement of cams above and below the turret that lift and lower the punches. In modern tablet press machines, pharmaceutical tablets are produced at rates as high as 12,000 tablets per minute.

It is highly desirable that all tablets prepared by rotary tablet press mechanisms be of uniform and precisely controlled size and weight. This is especially true for medicinal tablets because carefully prescribed dosage amounts are difficult to achieve without accurate tablet size and weight control. Inaccuracies in tablet size and weight stem from a variety of different circumstances. Various different failure modes of tables are illustrated in FIG. 1c. Inaccuracies can also result from imperfections or wear in the tablet press or die elements, or from changes in the density or moisture content of the powder being compressed. Also, punch head defects such as partially broken or deformed punch and/or die surfaces can result in loose metal debris, such as metal chips and particles which can get into the tablets/pills.

The following terms and phrases are used herein in accordance with the following meanings:

Coins—pieces, including metallic money (i.e., FIG. 1d), tokens, medals, medallions, rounds, planchets (i.e., FIG. 1e);

Obverse/Reverse—obverse is the side of a coin bearing the more important legends or types; its opposite side is the reverse.

Mint Luster—the sheen or “bloom” on the surface of a coin created by radial die marks, which are produced by minute imperfections or rough spots on the surface of the dies used to form the coin and by the centrifugal flow or metal when struck by those dies;

Strength of Strike—refers to the sharpness of design details within an object such as a coin. A sharp strike or strong strike is one with all the details of the die are impressed clearly into the coil; a weak strike has the details lightly impressed at the time of coining

In minting, coining is the process of manufacturing coins using a kind of stamping which is now generically known in metalworking as “coining”.

A coin die is one of the two metallic pieces that are used to strike one side of a coin. A die contains an inverse version of the image to be struck on the coin. To imagine what the inverse version looks like, one can press a coin into clay or wax and look at the resulting inverted image. Modern dies made out of hardened steel are capable of producing many hundreds of thousands of coins before they are retired and defaced.

On the edge of the US dime, quarter and half dollar, and many world coins there are ridges, similar to knurling, called reeds. Some older US coins, and many world coins have other designs on the edge of the coin. Sometimes these are simple designs like vines, more complex bar patterns or perhaps a phrase. These kinds of designs are imparted into the coin through a third die called a collar. The collar is the final size of the coin, and the planchet expands to fill the collar when struck. When the collar is missing, it results in a type of error called a broadstrike. A broadstruck coin is generally a bit flatter and quite a bit bigger around than the regular non-error coin of the same denomination.

The terminal die state is the last state in which any die is used. This state refers to a die that is starting to develop serious structural failures through cracks. A die in such a state would, if not removed from service, become unserviceable by breaking apart. Like any metallic part, dies are subject to failure from the enormous pressures used to impress the image of the dies onto the blank planchet. Some dies were removed when even a microscopic defect is observed.

More typically, a terminal die state will result in crack-like structures appearing on the coin. Crack-like structures appear like material that is overlaid onto the surface of the coin; this is because the crack on the die allowed the planchet material to flow into it during stamping, just like a deliberate design feature. Some coins exhibit multiple crack-like features, indicating a die that is very close to the end of its serviceable life.

WO 2009/130062 discloses a method and a device for the optical viewing of objects. The method includes the stages of illuminating an object with ultraviolet radiation, and acquiring an image of the object thereby illuminated using a lens comprising at least a forward optical group and an aperture diaphragm exhibiting a transparent window located at a focal point of the forward optical group defined for the ultraviolet radiation. WO 2005/022076 is also related to the present application.

U.S. patents documents related to the invention include: U.S. Pat. Nos. 4,315,688; 4,598,998; 4,644,394; 4,831,251; 4,852,983; 4,906,098; 4,923,066; 5,383,021; 5,521,707; 5,568,263; 5,608,530; 5,646,724; 5,291,272; 6,055,329; 4,983,043; 3,924,953; 5,164,995; 4,721,388; 4,969,746; 5,012,117; 6,313,948; 6,285,034; 6,252,661; 6,959,108; 7,684,054; 7,403,872; 7,633,635; 7,312,607, 7,777,900; 7,633,046; 7,633,634; 7,738,121; 7,755,754; 7,738,088; 7,796,278; 7,684,054; 7,802,699; and 7,812,970; and U.S. published patent applications 2005/0174567; 2006/0236792; 2010/0245850 and 2010/0201806.

### SUMMARY OF EXAMPLE EMBODIMENTS

In one example method embodiment, a method of inspecting small, manufactured objects and sorting the inspected objects is provided. Each of the objects has top, bottom and side surfaces and an axis. The method includes consecutively feeding and transferring the objects so that the objects travel along a path which extends from an object loading station and through a plurality of inspection stations including a first vision station. Each object to be inspected at the first vision station has an unknown orientation. Only one of the top and bottom surfaces of each object is viewable at the first vision station. The method further includes the steps of imaging the viewable surface of each object at the first vision station to obtain a first set of images of the objects, determining orientation of each object at the first vision station based on the first set of images of the objects, and processing each image of the first set of images with one of a top surface vision algorithm and a bottom surface vision algorithm depending on the determined orientations at the first vision station to identify objects having unacceptable defects. The method still further includes consecutively transferring objects from the first vision station to a second vision station. Each object to be inspected at the second vision has an orientation opposite its unknown orientation at the first vision station. Only the other one of the top and bottom surfaces of each object is viewable at the second vision station. The method further includes imaging the viewable surface of each object at the second vision station to obtain a second set of images of the objects, determining orientation of each object at the second vision station, and processing each image of the second set of images with the other one of the top surface vision algorithm and the bottom surface vision algorithm depending on the determined orientations at the second vision station to identify objects having unacceptable defects. The method finally includes directing objects identified as having an unacceptable defect to at least one defective object area.

The step of determining orientation of each object at the second vision station may be based on the second set of images.

The step of consecutively transferring from the first vision station to the second vision station may include the step of applying a vacuum to the objects to obtain the opposite orientation of each of the objects.

The inspection stations may include a circumference vision station wherein all of the side surfaces of each of the objects are viewable at the circumference vision station.

The method may further include simultaneously illuminating all of the side surfaces of each object with a plurality of separate beams of radiation when the object is located at the circumference vision station to generate corresponding reflected radiation signals, imaging the reflected radiation signals to generate a plurality of side images and processing the side images of each object with a side surface vision algorithm to identify objects having unacceptable defects.

The step of illuminating may include the step of generating a single beam of radiation and dividing or splitting the single beam of radiation into the separate beams of radiation. Each of the separate beams of radiation may be a reflected beam of radiation.

The objects may be tablets. The inspection stations may include an eddy current station. The method may further include generating an electromagnetic signature of each tablet located at the eddy current station and processing the signatures to identify tablets having unacceptable defects in the form of metallic debris.

At least one of the steps of imaging may be performed with a three-dimensional sensor to obtain three-dimensional information about the imaged surface.

In one example system embodiment, a system for inspecting small, manufactured objects and sorting the inspected objects is provided. Each of the objects has top, bottom and side surfaces and an axis. The system includes a feeder and a transfer subsystem to consecutively feed and convey the objects so that the objects travel along a path which extends through a plurality of inspection stations including a first vision station. Each object to be inspected at the first vision station has an unknown orientation. Only one of the top and bottom surfaces of each object is viewable at the first vision station. The system further includes a first imaging assembly to image the viewable surface of each object when the objects are located at the first vision station to obtain a first set of images of the objects. The system still further includes at least one processor for processing the first set of images to determine orientation of each object at the first vision station and to identify objects having an unacceptable defect based on the determined orientations. The transfer subsystem consecutively conveys objects from the first vision station to a second vision station of the inspection stations. Each object to be inspected at the second vision station has an orientation opposite the unknown orientation at the first vision station. Only the other one of the top and bottom surfaces of each object is viewable at the second vision station. The system further includes a second imaging assembly to image the viewable surface of each object when the objects are located at the second vision station to obtain a second set of images of the objects. The system still further includes means for determining orientation of each object at the second vision station. The at least one processor processes the second set of images to identify objects having an unacceptable defect based on the determined orientations at the second vision station. The system further includes at least one object sorter for directing objects identified as having an unacceptable defect to at least one defective object area and a system controller coupled to the transfer subsystem, each of the imaging assemblies, the at least one processor and the at least one object sorter for controlling the sorting based on the inspections.

The at least one processor may determine orientation of each object at the second vision station based on the second set of images.

The transfer subsystem may include a vacuum transfer conveyor including a perforated conveyor belt. A top or bottom surface of each of the objects is held against a surface of the belt to obtain the opposite orientation.

The transfer subsystem may include first and second vacuum transfer drums and a mechanism for synchronously rotating the drums. The first rotating drum may convey objects at equal intervals to the first vision station. The second rotating drum may convey the objects supplied by the first drum at equal intervals to the second vision station.

The inspection stations may include a circumference vision station at which a third imaging assembly may be located. All of the side surfaces of each of the objects are viewable at the circumference vision station by the third imaging assembly.

The third imaging assembly may include a side illumination assembly to simultaneously illuminate a plurality of side surfaces of the object which are angularly spaced about the axis of the object with a plurality of separate beams of radiation when the object is located at the circumference vision station. The third imaging assembly may further include a telecentric lens and detector assembly to form an optical image of at least a portion of each of the illuminated side surfaces of the object and to detect the optical images. The at least one processor processes the detected optical images to obtain a plurality of views of the object which are angularly spaced about the axis of the object.

The telecentric lens may include a forward set of optical elements having an optical axis and an aperture diaphragm. The diaphragm may be provided with a transparent window substantially centered on the optical axis and located at a focal point along the optical axis of the forward set of optical elements.

The telecentric lens may further include a rear set of optical elements having a focal point. The diaphragm may be interposed between the forward and rear sets of optical elements with the transparent window located at the focal points of the forward and rear sets of optical elements.

The detector may include an image sensor having an image plane to detect the optical images.

The side illumination assembly may include a source of radiation and a mirror subassembly to receive and divide the radiation into the plurality of separate beams of radiation.

The objects may be tablets. The inspection stations may include an eddy current station. The system may further include an eddy current subsystem for generating an electromagnetic signature of a tablet when the tablet is located at the eddy current station and a signature processor for processing the signatures to identify tablets having an unacceptable defect in the form of metallic debris.

The first imaging assembly may include a three-dimensional sensor and the second imaging assembly may also include a three-dimensional sensor.

Other technical advantages will be readily apparent to one skilled in the art from the following figures, descriptions and claims. Moreover, while specific advantages have been enumerated, various embodiments may include all, some of or none of the enumerated advantages.

### BRIEF DESCRIPTION OF THE DRAWINGS

For a more complete understanding of the present invention, and for further features and advantages thereof, reference is made to the following description taken in conjunction with the accompanying drawings, in which:

FIG. 1a is a schematic perspective view of a plurality of common disk-shaped tablets which can be inspected and sorted with at least one embodiment of the present invention;

FIG. 1b is a schematic perspective view of a plurality of different tablets which can be distinguished and sorted by both color and shape utilizing at least one embodiment of the present invention;

FIG. 1c is a schematic perspective view of a plurality of defective tablets wherein the top tablet has a “capping” failure and the right tablet has a lamination failure;

FIG. 1d is a schematic perspective view of a plurality of coins some of which form a stack and which can be inspected and sorted utilizing at least one embodiment of the present invention;

FIG. 1e as a top plan view of a coin blank or planchet which can be inspected and sorted in accordance with at least one embodiment of the present invention;

FIG. 2a is a side schematic view of a feeder and conveyors of a transfer subsystem constructed in accordance with at least one embodiment of the present invention;

FIG. 2b is a top plan view of the feeder and conveyors shown in FIG. 2a;

FIG. 3 is a block diagram schematic view of a portion of a system including a vacuum transfer conveyor of at least one embodiment of the invention at first and second vision stations and a reject station;

FIG. 4a is a side view, partially broken away and in cross section, of a conveyor belt of the vacuum transfer conveyor of FIG. 3 wherein rows of tablets are held via a vacuum against a bottom surface of a perforated belt;

FIG. 4b is a side view, partially broken away and in cross section, of the conveyor belt of the vacuum transfer conveyor of FIG. 3 wherein a single row of coins are held via a vacuum against the bottom surface of the perforated belt;

FIG. 5 is a top schematic block diagram view, partially broken away, of a mirror subassembly (in phantom), a vacuum transfer conveyor and its drive and a system controller of an embodiment of the invention at a circumference vision station;

FIG. 6 is a side schematic block diagram view, partially broken away and in cross section, of a source of illuminating radiation, a partially reflective mirror, the conveyor of FIG. 5 and a telecentric lens and detector assembly associated with the mirror subassembly of FIG. 5 at the circumference vision station;

FIG. 7 is a top plan schematic block diagram view, partially broken away, of an illumination assembly, the telecentric lens and detector assembly of FIG. 6, the conveyor of FIG. 6 and the system controller to obtain a view of one of the side surfaces of a coin at the circumference vision station wherein a plurality of reject stations and an eddy current station are also shown.

FIG. 8a is a side schematic view of a feeder and conveyors of a transfer subsystem constructed in accordance with a second embodiment of the present invention;

FIG. 8b is a top plan view of the feeder and conveyors shown in FIG. 8a;

FIG. 9 is a block diagram schematic view of a portion of a system including a pair of vacuum transfer drums of a second embodiment of the invention and further including a pair of imaging or camera assemblies at vision stations and a reject station;

FIG. 10 is a block diagram schematic view, partially broken away, of a plurality of air jets (one for each circular column) located at the reject station;

FIG. 11 is an exploded assembly view of one of the vacuum transfer drums for transferring an array of pills or tablets; and

FIG. 12 is a schematic perspective view of one of the vacuum transfer drums for coins.

### DETAILED DESCRIPTION OF EXAMPLE EMBODIMENTS

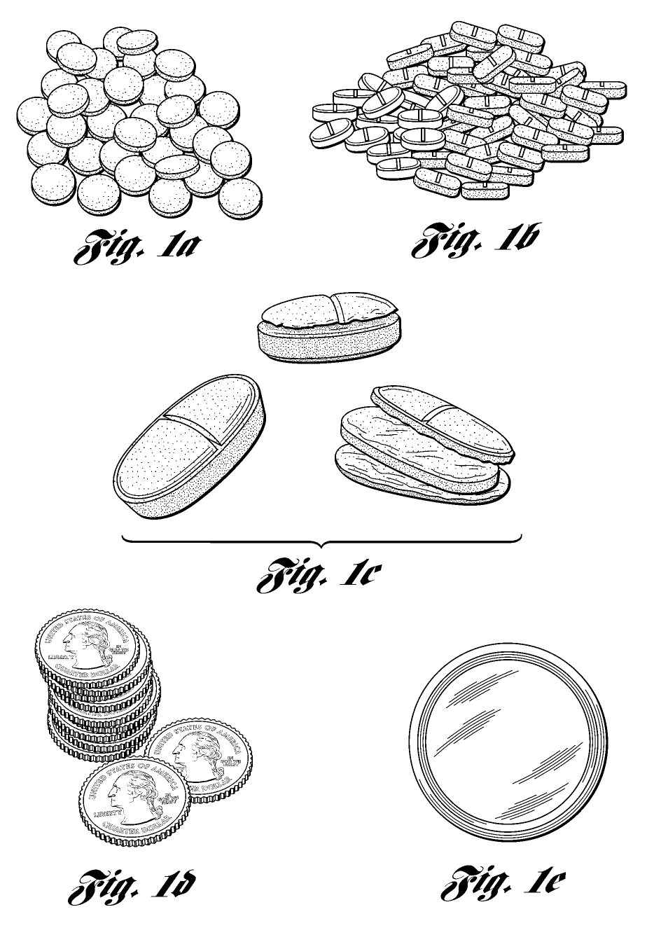

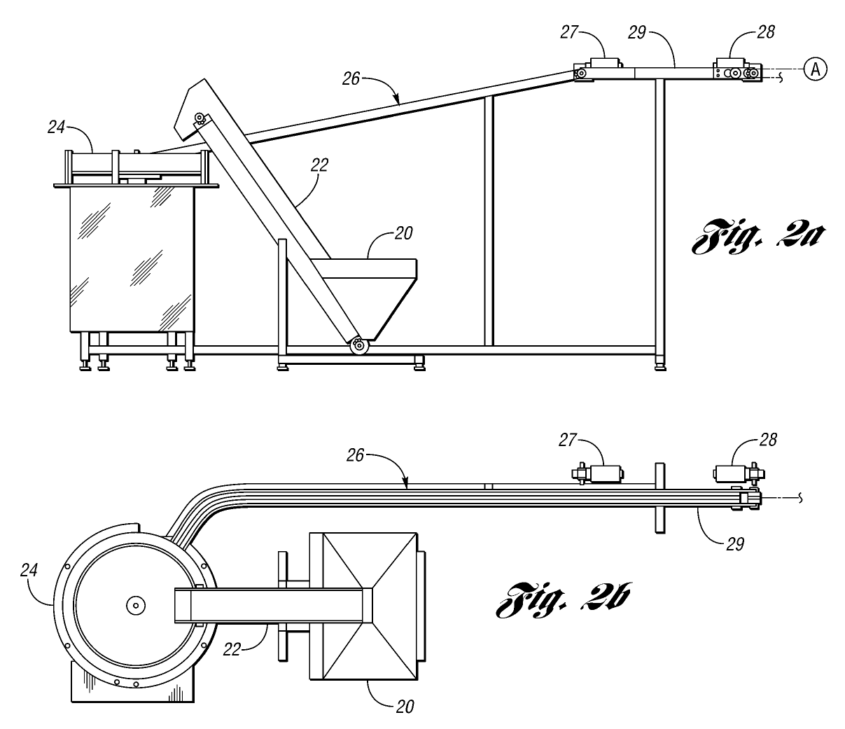

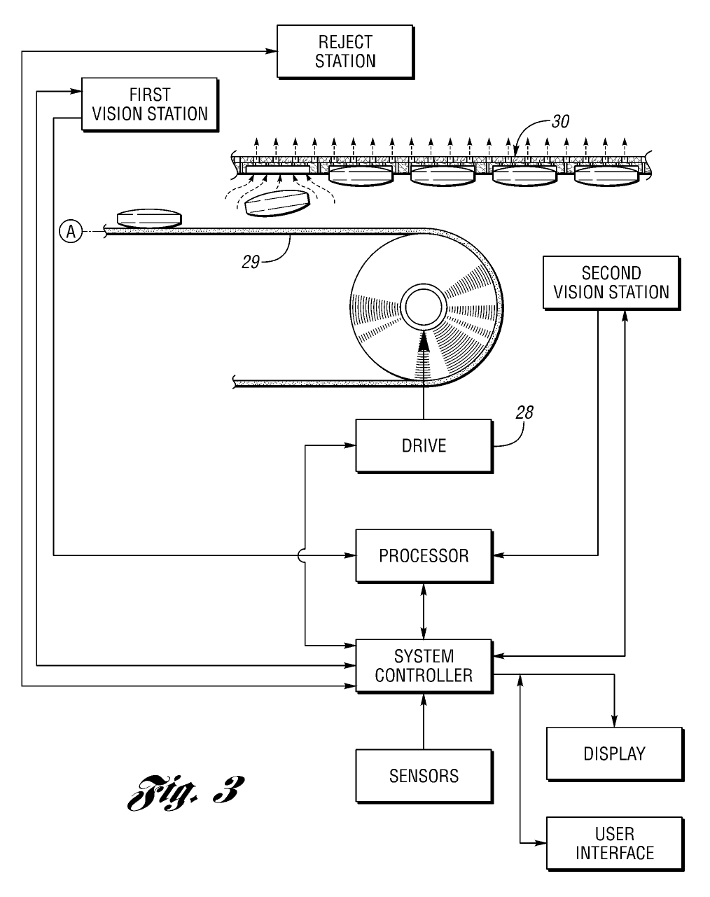

In general, one embodiment of the method and system of the present invention inspects manufactured objects such as pharmaceutical tablets, pills, tokens, coins, medals and planchets, some of which are illustrated in FIGS. 1a-1e and sorts the inspected objects. The system is a complete system designed for the inspection and sorting of small manufactured objects. However, the method and system are also suitable for inspecting and sorting other small, mass-produced manufactured objects wherein objects manufactured by metal forming dies (which can crack and/or cause metal debris when broken) are of concern. The system includes subsystems which may be used for object handling and delivery and can vary widely from application to application depending on object size and shape as well as what inspections are being conducted at inspection stations. The subsystems or assemblies ultimately chosen for object handling and delivery generally have some bearing on the nature of the subsystems conducting the various inspections, including visual inspections by imaging assemblies.

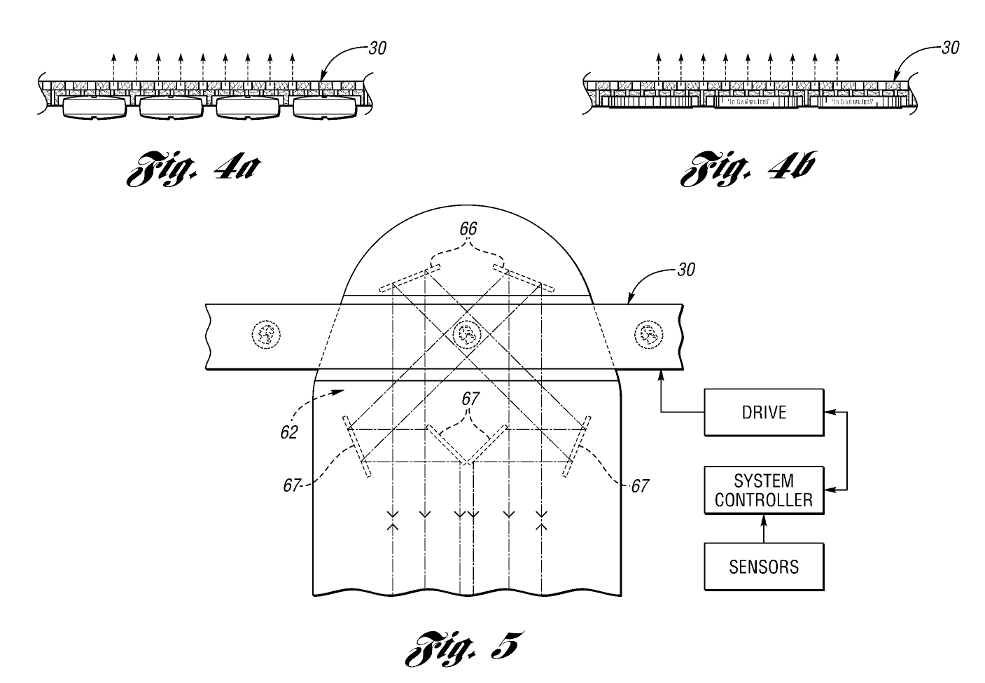

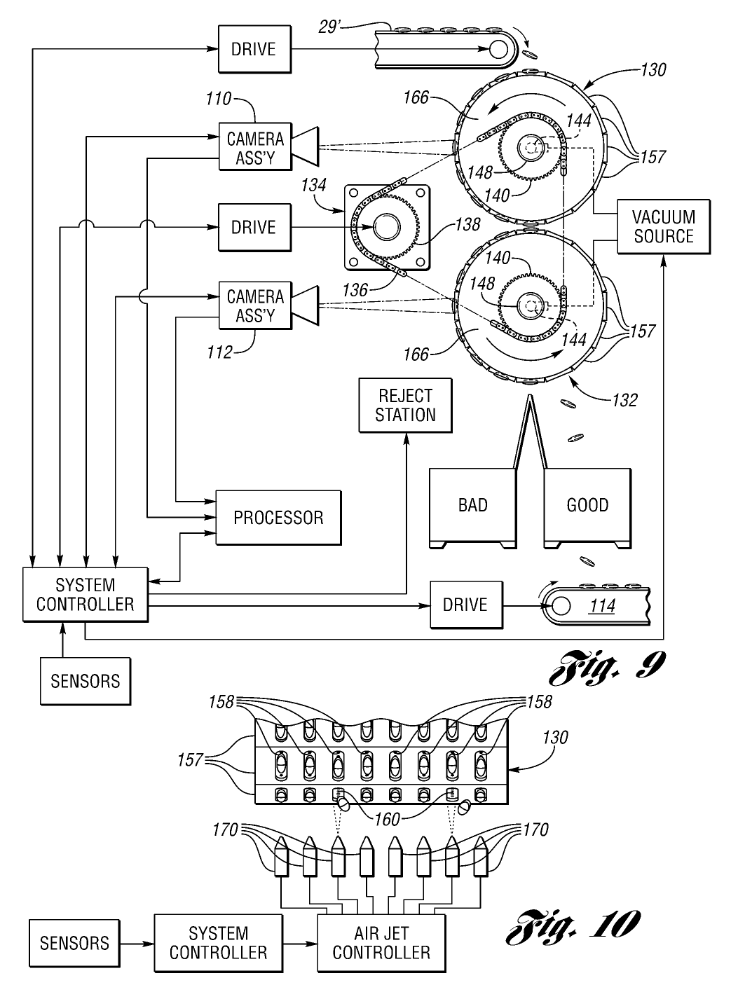

Referring now to FIGS. 2a and 2b, one embodiment of the system may accept objects from an infeed hopper 20 at one end and automatically feeds and conveys the objects in one or more columns or rows through a number of inspecting or inspection stations as illustrated in FIGS. 3, 5, 6 and 7. In another embodiment of the system, as illustrated in FIGS. 8a and 8b, the infeed hopper, conveyors and drums provide an equally spaced array of objects for inspection. At a high level, each of the embodiments of the system is comprised of a feeder and two major subsystems, a transfer subsystem and an inspection machine subsystem. Each major subsystem features a modular design with several possible upgrades providing varying levels of inspection capability.

Referring again to FIGS. 2a and 2b, objects to be sorted are initially loaded into the hopper 20 where they are conveyed and dumped at a controlled rate by a conveyor 22 into a centrifugal feeder bowl 24 having a scalloped rim. The bowl 24 loads objects into radially oriented scallops on the outer rim. Every object passes out of the feeder bowl 24 and down a drop tube (not shown) and in the first embodiment, onto a conveyor 26 which conveys them to a vacuum conveyor 30 (FIG. 3). The conveyor 26 is driven by a pair of electric motors or drives 27 and 28 and the objects are carried in a single row or in a few rows on an upper reach of a belt 29 of the conveyor 26.

Objects are provided to the inspection machine subsystem by the transfer or conveyor subsystem at controlled regular and preferably equal intervals. The inspection machine subsystem of the first embodiment includes several inspection stations as shown in FIGS. 3, 5, 6 and 7 located along the path of conveyance. As the objects are conveyed by the conveyors 26 and 30, the objects pass by or through the inspection stations and are inspected. Objects which pass each of the inspections (have no unacceptable defects) may be actively accepted by a part diverter or flipper (not shown for the first embodiment) located at the end of the path of conveyance. Alternatively, objects which pass all of the inspections may be passively accepted and objects which fail at least one of the inspections are actively rejected. The inspection stations located throughout the inspection machine subsystem may include one or more of the following modular inspection stations: first and second vision, eddy current, and single-camera circumference vision.

With respect to the circumference vision station, a telecentric subsystem or imaging assembly provides multiple side imaging of the objects. One aspect of one embodiment of the present invention relates to a novel method and configuration which uses a telecentric subsystem including a telecentric or bi-telecentric lens to optically inspect objects which are received and suspended on a conveyor such as a vacuum conveyor which moves the objects between the inspection stations. At the circumference vision inspection station the objects have a predetermined position for optical inspection of the side surfaces of the objects.

Referring again to FIG. 3, there are illustrated an example embodiment of a system for inspecting objects such as tablets or pills and coins. The system of FIG. 3 includes the conveyor subsystem adapted to receive and retain objects from the feeder subsystem of FIGS. 2a and 2b. The conveyor subsystem transfers or conveys objects so that they travel along a path which extends from the loading station to a first inspection or vision station at which objects have a predetermined position but unknown orientation for machine vision inspection. Subsequently, the vacuum conveyor of the conveyor subsystem transfers or conveys the objects after inspection at the first vision station by a first imaging or camera assembly so that the inspected objects travel along a path which extends from the first vision station to a second vision station for further machine vision inspection by a second imaging or camera assembly.

As further illustrated in FIG. 3, a drive of the conveyor 26 operates to rotate the belt 29 based on various sensor input signals from sensors to the system controller which, in turn, provides sequential control signals to the drive. The system controller also provides control signals to a computer display, object sorters (for example, air nozzles or jets at one or more reject stations) and to the imaging assemblies at the first, second and circumference vision stations.

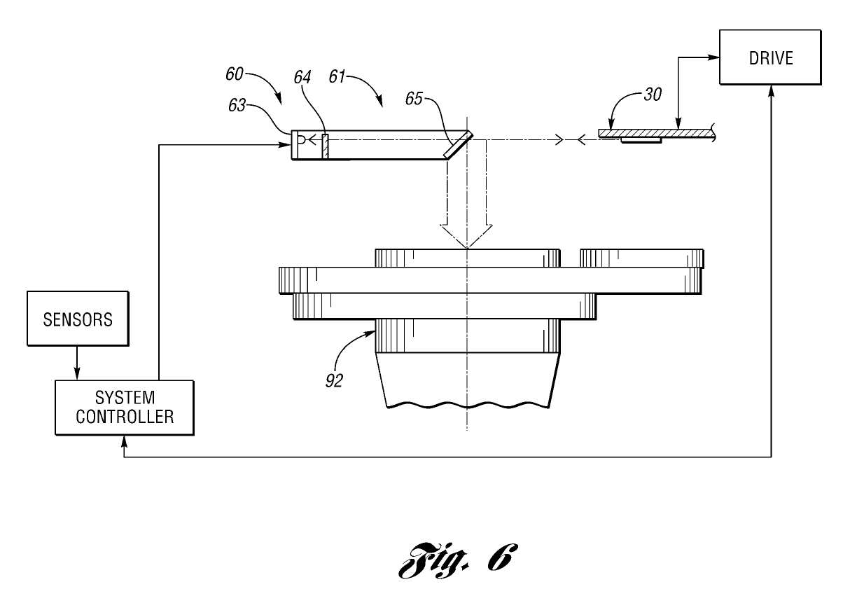

As illustrated in FIGS. 3, 4a and 4b, the vacuum transfer conveyor has a conveyor belt from which objects, such as tablets (in a single row in FIG. 3 and in multiple rows in FIG. 4a) or coins (lettering on one of the side surfaces is visible in FIG. 4b) hang or are suspended to enable optical inspection of the viewable top or bottom surfaces of the objects depending on which of the first and second vision stations the objects are located. Typically, such vacuum belt conveyors are capable of transferring small objects or articles between stations while maintaining a predetermined position and vertical orientation of the object. Such conveyors or conveyor apparatus typically include a vacuum plenum or mechanism for obtaining a vacuum in the plenum, a plurality of spaced air openings in a plenum wall as well as an apertured vacuum transfer belt having a reach mounted for movement along an outer surface of the plenum wall. The holes and object-holding depressions in the vacuum conveyor belt are spaced at regular or equal intervals to provide a “metering effect” which allows the proper spacing of objects for inspection and rejection of defective objects.

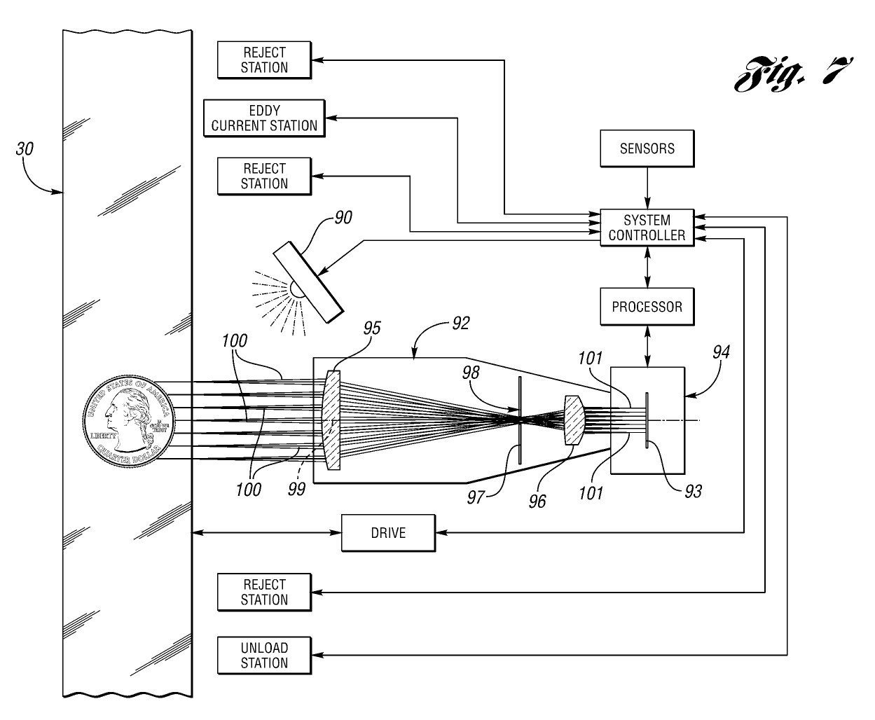

Referring now to FIGS. 5 and 6, there is illustrated a first embodiment of an illumination assembly, generally indicated at 60, to simultaneously illuminate a plurality of exterior side surfaces of objects such as the coins supported on the vacuum conveyor. The side surfaces are angularly spaced about the axis of a coin and are illuminated with a plurality of separate beams of radiation when the coin is located at the circumference vision station.

The illumination assembly 60 includes a diffusive source 61 of radiation and a mirror subassembly, generally indicated at 62, to receive and divide the radiation into the plurality of separate beams of radiation as shown in FIG. 5. The source 61 of radiation includes an LED emitter 63 controlled by the system controller and at least one optical element 64 or diffuser to diffuse the rays of radiation emitted by the emitter 63. The emitter 63 includes at least one row of LED's. The illumination assembly 60 also includes a partially reflective mirror or beam splitter 65 interposed between the source 61 and the mirror subassembly 62 to allow the radiation to pass therethrough in a first direction and to prevent radiation from passing therethrough in a second direction opposite the first direction.

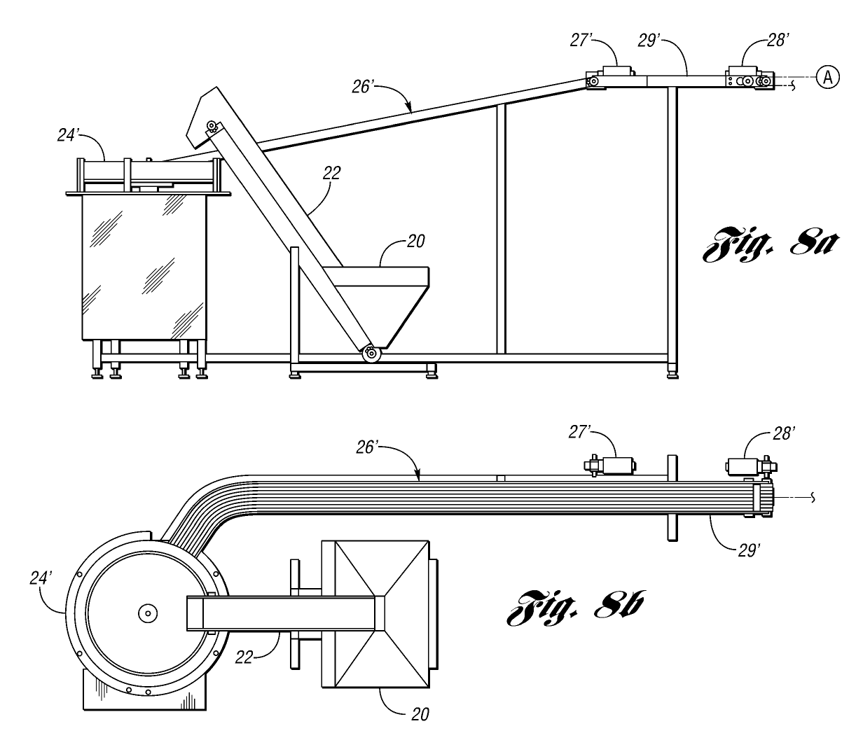

The beam splitter 65 is located within the optical path to direct light energy reflected back along the optical path from the coin to a telecentric lens 92 and a detection device 94 (shown in detail in FIG. 7) which typically includes a camera, which may be a digital CCD camera (e.g.; color or black/white) and an associated frame grabber (or digital frame buffer provided with the camera), which digitizes the video output from the television camera to obtain pixel data representing a two-dimensional image of each side surface of the coin. The pixel data are stored in a memory of the frame grabber, or transmitted, for instance, by a high speed link, directly to the processer of FIGS. 3 and 7 or to a separate processor.

The mirror subassembly 62 includes at least one mirror and preferably two mirrors 66 disposed on one side of the path along which the coins travel and at least one mirror and preferably four mirrors 67 disposed on the opposite side of the path as shown in FIG. 5.

The detected optical images are processed by the processor to determine defects located at the side surfaces of the coins. Text recognition may also be implemented by the processor.

As described in greater detail hereinbelow, defect detection in each region of each side surface can be conducted by first running several image processing algorithms and then analyzing the resultant pixel brightness values. Groups of pixels whose brightness values exceed a preset threshold are flagged as a “bright defect”, while groups of pixels whose brightness values lie below a preset threshold are flagged as a “dark defect”. Different image processing techniques and threshold values are often needed to inspect for bright and dark defects, even within the same side surface region.

The system of FIGS. 5 and 6 includes an integrated opto-mechanical subsystem designed to fully inspect and measure objects from their sides without any need for object rotation at the circumference vision station. The system of FIGS. 5 and 6 can inspect objects which are supported to stand upright or which can be suspended as illustrated.

Four orthonormal partially overlapped views of the object are simultaneously provided to the device 94 by the telecentric lens 92 through the array of mirrors 62. The optical path is designed so that the displacement angle between the views is almost exactly 90°. This optical layout ensures complete coverage of the coin's lateral surfaces. The optical path is the same for all four viewpoints. Furthermore, telecentric imaging makes the system insensitive to coin (or tablet) decentering and therefore suitable for measurement applications. The subsystem is a solution for inspecting objects, such as tablets and coins, whose features would be hidden when looked at from the top or the bottom and for all those applications where an object is to be inspected or measured from different sides without object rotation.

Referring to FIG. 7, there is illustrated an illumination assembly or radiant source 90 for illuminating an object such as a coin to be imaged, and the telecentric optical lens 92 for receiving the reflected radiation from the coin and directing it towards an image plane 93 of the image acquisition device or detector, generally referred as 94. Coins are received and retained at predetermined positions on the vacuum conveyor.

The illumination assembly 90 is provided for illustrative purposes in FIG. 7, but it is to be understood that the preferred illumination assembly for coins (or tablets) is illustrated in FIGS. 5 and 6. Consequently, the radiation source 90 preferably comprises a LED emitter including at least one row of LED emitter elements serving to emit radiation in either the visible or ultraviolet range. The LED emitter of the source 90 is preferably high power, capable of generating 100 optical mW or more for each emitting element. Also, the illumination assembly includes the mirror subassembly 62 wherein a plurality of side surfaces are illuminated and reflect light to the lens 92 for simultaneous imaging on the image plane 93.

Such an optical or optoelectronic device for the acquisition of images (for example the camera or telecamera 94) has the image plane 93 which can be, for example, an electronic sensor (CCD, CMOS). Preferably the device 94 is a high resolution digital telecamera, having the electronic sensor 93 with individual pixels of lateral dimensions equal to or less than one or more microns.

The lens 92 schematically comprises a forward set of optical elements 95 proximal to the coin, a rear set of optical elements 96 proximal to the acquisition device 94 and an aperture diaphragm 97 interpose between the forward set and the rear set of optical elements 95 and 96, respectively. The aperture diaphragm 97 comprises a circular window 98 transparent to the radiation, which is referred to as a diaphragm aperture. For example, the aperture diaphragm 97 can comprise an opaque plate preferably of thickness of a few tenths of a millimeter, and the diaphragm aperture can be defined as a simple hole in the plate.

The diaphragm aperture or window 98 is coaxial to the optical axis 99 of the forward set of optical elements 95, and positioned on the focal plane of the forward set 95 defined for the wavelength range of radiation emitted by the radiant source 90. The position of the focal plane of a set of optical elements mostly depends on the refraction index of the material from which the lenses are made, which, in turn, depends on the wavelength of the electromagnetic radiation passing through the lenses.

The lens 92 only accepts ray cones 100 exhibiting a main (barycentric) axis that is parallel to the optical axis 99 of the forward set 95. Thereby, the lens 92 is a telecentric lens configured for the particular radiation. The rear set of optical element 96 serves to compensate and correct the residual chromatic dispersion generated by the forward set of optical elements 95 for the wavelength in question.

The optical axis of the rear set 96 coincides with the optical axis 99 of the forward set 95 and the focal plane of the rear set 96 defined for the wavelength cited above, coincides with the plane on which the aperture diaphragm 97 is located. Consequently, rays of radiation 101 conveyed by the rear set 96 towards the image plane 93 form light cones, the main (barycentric) axis of which is parallel to the optical axis 99 of the lens 92.

The lens 92 is therefore both telecentric on the object side and telecentric on the image side, and overall the lens 92 is a bi-telecentric lens configured for light such as visible light or ultraviolet light. It may be preferable that the lens 92 is optimized for operation with radiation in the ultraviolet range, such that the choice of materials from which the lenses are composed, and the characteristics of the lenses, including for example the curvature radius, thickness and spatial position, permit the lens 92 to operate in the above indicated wavelength range exhibiting very high contrast and with performance close to the diffraction limit.

Referring still to FIG. 7, the aperture 98 may have a diameter of a few mm. In use, the object or coin is positioned in front of the bi-telecentric lens 92 where it is illuminated with radiation emitted by the radiant source 90. The radiation reflected by the coin passes through the bi-telecentric lens 92 and an image is formed on the sensor 93 of the telecamera or digital camera 94 for each side surface of the coin which is illuminated.

The images obtained with the bi-telecentric lens 92 are images substantially without errors of perspective and wherein the image size of the observed coin or tablet is independent of the distance from the coin. The use of the bi-telecentric lens 92 with radiation in the preferred range also provides a high resolution image, exhibiting a level of detail of less than ten microns, compatible with the maximum resolution of the electronic sensor 93 of the telecamera 94.

The lens 92 used in the wavelength range is therefore particularly suited for use with devices 94 capable of high resolution image acquisition, wherein the individual image point (pixel) is very small, and wherein the density of these pixels is very high, thereby enabling acquisition of highly detailed images.

An image acquired in this way will comprise a high numbers of pixels, each of which contains a significant geometric datum based the high performance of the lens 92 operating in the wavelength range, thereby being particularly useful for assessing the dimensions of the object viewed by the lens 92. The high level of detail provided by the individual pixels of the device 94 enables, after suitable processing of the image, an accurate determination of the outline of the object to be made, improving the efficiency of “edge detection” machine vision algorithms, which select, from a set of pixels making up an image, those pixels that define the border of the objects depicted, and thereby to establish the spatial positioning and the size of the objects as well as features on the side surfaces.

Consequently, the assembly of FIG. 7 offers a significant improvement in the accuracy of images in any type of application based on machine vision viewing, in particular in the field of optical metrology, this being dimensional measuring of object features, without contact, of objects, for example manufactured objects including medicinal tablets as well as coins.

An eddy current station of FIG. 7 includes an eddy current sensor which generates an electromagnetic signature of the part and compares it with a saved “good” part profile. This comparative test can be tuned to detect the presence or absence of metal debris in or on conveyed tablets. The eddy current sensor includes coils which not only induce an eddy current in the metal debris, but also sense the induced eddy current to provide a signal to an eddy current module, which represents the amount of induced eddy current.

Pencil light beams from emitters and associated sensors may be provided to monitor the progress of tablets or coins as they are conveyed. Also, feedback signals from sensors associated with the various drivers of the system may be used to monitor the progress of tablets or coins as they are being conveyed. Each pencil light beam is associated with a small control unit or hardware trigger or sensor that produces an electrical pulse when a light beam is blocked. The pulse is referred to as a “trigger”. Two of these are typically associated with the eddy current hardware. For eddy current, these essentially provide a “great ready”, then a “get set” signal to the hardware which then controls the induced eddy current. The eddy current subsystem is typically a commercially available subsystem.

The software for the eddy current subsystem displays the electromagnetic signature of a tablet on the complex impedance plane. The software is a purely comparative tool, generating no quantitative data. Several coil sizes are commercially available. Additionally, coil frequency, AC gain and DC gain can be adjusted to generate a signature plot which is as large as possible without saturating the sensor.

In general, when setting up for inspecting a new object whether a tablet or a coin, the user chooses surface “features” of the object to be measured via the user interface. The types of features include design dimensions and eddy current signature. For most features, the user chooses a region of the object where the measurement will be made, a nominal value of the measurement, and plus and minus tolerances. For some features, such as eddy current, the measurement region is the whole object. Also, for eddy current the user chooses a rectangle on an eddy screen of the display instead of a nominal value and tolerances. If the eddy signature hits the rectangle, than the object is good.

More particularly, in creating a template, a gold or master object with known good dimensions and surface features and without defects is conveyed in the system after which the particular object is named. After the object has traveled the length of the path, one or more images of the object is displayed on the display.

Software locates and defines several regions of interest on the object and inspects those regions using any number of customizable tools for user-defined defects. In order to allow the system to be able to locate and recognize a wider variety of defects, exterior side surfaces of the part are illuminated from a variety of angles as previously described.

In view of the above, the following are important considerations in the design of the illumination and telecentric lens and detector assemblies of the third imaging or camera assembly:

Standard telecentric lenses operate in the visible range;

In order to use an ultraviolet (UV) illuminator, it would be necessary to replace both the LED illuminator and the telecentric (TC) lens with the equivalent UV structures.

UV telecentric setups offer more contrast information at higher spatial frequencies compared to lenses operating in the visible range.

UV telecentric setups offer more contrast information at higher spatial frequencies compared to lenses operating in the visible range.

Telecentric lenses that are telecentric only in object space accept incoming rays that are parallel to the main optical axis. However, when those rays exit the optical system, they are not parallel anymore and would strike the detector at different angles. This results in:
lower constancy in magnification; and
point spread function inhomogeneity (spots in image space would change in size depending on the position on the detector plane).
   In bi-telecentric lenses, the optical rays remain parallel in image space. That means increased constancy in magnification, more consistent information over the entire detector plane, superior depth of field.

### Data/Image Processor for the Detection of Surface Defects on Small Manufactured Parts

The vision subsystems for the first embodiment described above and for the second embodiment described below are especially designed for the inspection of the top, bottom and side surfaces of relatively small manufactured objects such as pharmaceutical tablets and coins. The processing of object images or resulting data to detect defective objects in each of the embodiments can be performed as follows.

### Detection of Object Defects Such as Chips, Cracks and Perforations

The detection of surface dents, chips or cracks typically relies on the alteration of the angle of reflected light caused by a surface deformation on the inspected object. Light which is incident on a surface dent will reflect along a different axis than light which is incident on a non-deformed section.

There are generally two ways to detect dents using this theory. One option is to orient the light source so that light reflected off the object exterior is aimed directly into the camera aperture. Light which reflects off a dented or cracked region will not reflect bright background. Alternatively, the light source can be positioned with a shallower angle to the object. This will result in a low background illumination level with dents appearing as well deemed origin spots on the image.

Detecting perforations uses both of the principles outlined above. The task is much simpler however, as the region containing the defect is completely non-reflective. Therefore, perforations are visible as dark spots on surfaces illuminated by either shallow or steep angle illumination.

Because the object to be viewed is essentially at a pre-defined location but unknown orientation when the images are acquired, the software to locate objects and their orientation and to identify regions of interest use preset visual clues.

Defect detection in each region of interest is typically conducted by first running several image processing algorithms and then analyzing the resultant pixel brightness values. Groups of pixels whose brightness values exceed a preset threshold are flagged as a “bright defect,” while groups of pixels whose brightness values lie below a preset threshold are flagged as a “dark defect.” Different image processing techniques and threshold values are often needed to inspect for bright and dark defects, even within the same object region.

Previously locating the object in the image may be accomplished by running a series of linear edge detection algorithms. These algorithms use variable threshold, smoothing and size settings to determine the boundary between a light and dark region along a defined line. These variables are not generally available to the user, but are hard-coded into the software, as the only time they will generally need to change is in the event of large scale lighting adjustments.

Once the object has been located in the image, a framework of part regions is defined using a hard-coded model of the anticipated part shape and surface designs. Each of these regions can be varied in length and width through the user interface in order to adapt the software to varying object sizes.

Once the regions have been defined, a buffer distance is applied to the inside edges of each region. These buffered regions define the area within which the defect searches will be conducted. By buffering the inspection regions, edge anomalies and non-ideal lighting frequently found near the boundaries are ignored. The size of the buffers can be independently adjusted for each region as part of the standard user interface and is saved in an object profile.

There are two general defect detection algorithms that can be conducted in each region. These two algorithms are closely tied to the detection of dents and perforations respectively as discussed above. More generally however, they correspond to the recognition of a group of dark pixels on a bright background or a group of bright pixels on a dark background.

Although there may be only two defect detection algorithms used across all the regions on the object, the parameters associated with the algorithm can be modified from region to region. Additionally, the detection of dark and/or bright defects can be disabled for specific regions. This information is saved in the object profile.

The detection of dark defects may be a 6 step process.

1. Logarithm: Each, pixel brightness value (0-255) is replaced with the log of its brightness value. This serves to expand the brightness values of darker regions while compressing the values of brighter regions, thereby making it easier to find dark defects on a dim background.

2. Sobel Magnitude Operator: The Sobel Operator is the derivative of the image. Therefore, the Sobel Magnitude is shown below:

$${S}_{M} = \sqrt{{( \frac{\partial f}{\partial x} )}^{2} + {( \frac{\partial f}{\partial y} )}^{2}}$$

although it is frequently approximated as follows:

$${S}_{M} = \frac{\frac{\partial f}{\partial x} + \frac{\partial f}{\partial y}}{2}$$

The Sobel Magnitude Operator highlights pixels according to the difference between their brightness and the brightness of their neighbors. Since this operator is performed after the Logarithm filter applied in step 1, the resulting image will emphasize dark pockets on an otherwise dim background. After the Sobel Magnitude Operator is applied, the image will contain a number of bright ‘rings’ around the identified dark defects.

3. Invert Original Image: The original image captured by the camera is inverted so that bright pixels appear dark and dark pixels appear bright. This results in an image with dark defect areas appearing as bright spots.

4. Multiplication: the image obtained after step 2 is multiplied with the image obtained after step 3. Multiplication of two images like this is functionally equivalent to performing an AND operation on them. Only pixels which appear bright appear in the resultant image. In this case, the multiplication of these two images will result in the highlighting of the rings found in step two, but only if these rings surround a dark spot.

5. Threshold: All pixels with a brightness below a specified value are set to OFF while all pixels greater than or equal to the specified value are set to ON.

6. Fill in Holes: The image obtained after the completion of steps 1-5 appears as a series of ON-pixel rings. The final step is to fill in all enclosed contours with ON pixels.

After completing these steps, the resultant image should consist of pixels corresponding to potential defects. These bright blobs are superimposed on areas that originally contained dark defects.

The detection of bright defects may be a two-step process.

1. Threshold: A pixel brightness threshold filter may be applied to pick out all saturated pixels (greyscale255). A user-definable threshold may be provided so values lower than 255 can be detected.

2. Count Filter: A count filter is a technique for filtering small pixel noise. A size parameter is set (2, 3, 4, etc.) and a square box is constructed whose sides are this number of pixels in length. Therefore, if the size parameter is set to 3, the box will be 3 pixels by 3 pixels. This box is then centered on every pixel picked out by the threshold filter applied in step 1. The filter then counts the number of additional pixels contained within the box which have been flagged by the threshold filter and verifies that there is at least one other saturated pixel present. Any pixel which fails this test has its brightness set to 0. The effect of this filter operation is to blank out isolated noise pixels.

Once these two steps have been completed, the resultant binary image will consist of ON pixels corresponding to potential defects. Furthermore, any “speckling” type noise in the original image which would have results in an ON pixel will have been eliminated leaving only those pixels which are in close proximity to other pixels which are ON.

After bright and/or dark defect detection algorithms have been run in a given region, the resultant processed images are binary. These two images are then OR'ed together. This results in a single image with both bright and dark defects.

The software now counts the number of ON pixels in each detected defect. Finally, the part may be flagged as defective if either the quantity of defect pixels within a given connected region is above a user-defined threshold, or if the total quantity of defect pixels across the entire object is above a user-defined threshold.

Each of the first and second vision stations may include a three-dimensional imaging subsystem or sensor such as a confocal or triangulation-based subsystem or sensor to obtain 3D images, information or data. The processor processes the 3D data to obtain dimensional or design information related to the object. The image data is both acquired and processed under control of the system controller in accordance with one or more control algorithms. The data from the sensors are processed for use with one or more measurement algorithms to thereby obtain dimensional or design information about the top and bottom surfaces of the object.

Each confocal or triangulation-based subsystem or assembly typically includes a confocal or triangulation-based sensor, respectively, having a laser for transmitting a laser beam incident on the object from a first direction to obtain reflected laser beams and at least one detector (and preferably two detectors) positioned with respect to the laser beam incident on the object. The sensor is disposed adjacent the object to illuminate the object with the beam of laser energy. Analog signals from the detectors are processed to obtain digital signals or data which can be processed by the processor.

Referring now to FIGS. 8a and 8b, another embodiment of the system may accept objects such as coins or tablets from the infeed hopper 20 at one end and automatically feeds and conveys the objects in a plurality of columns or rows (i.e., an array of objects) through a number of inspecting or inspection stations (i.e., past the upper and lower camera assemblies 110 and 112, respectively, illustrated in FIG. 9). Objects to be sorted are initially loaded into the hopper 20 where they are conveyed and dumped at a controlled rate by a conveyor 22 into a centrifugal feeder bowl 24′ having a scalloped rim. The bowl 24′ loads objects into radially oriented scallops on the outer rim. Every object passes out of the feeder bowl 24′ and down a drop tube (not shown) and onto a conveyor 26′ which conveys and drops them onto a first or upper vacuum transfer drum, generally indicated at 130, which is rotatably supported (support not shown) to rotate about an axis 152 and transfer the array of objects to a second or lower vacuum transfer drum, generally indicated at 132 which is also rotatably supported (support not shown). The conveyor 26′ is driven by a pair of electric motors or drives 27′ and 28′ and the objects are carried as a plurality of rows (i.e., 8 or more, typically) in an array-like fashion on an upper reach of a belt 29′ of the conveyor 26′.

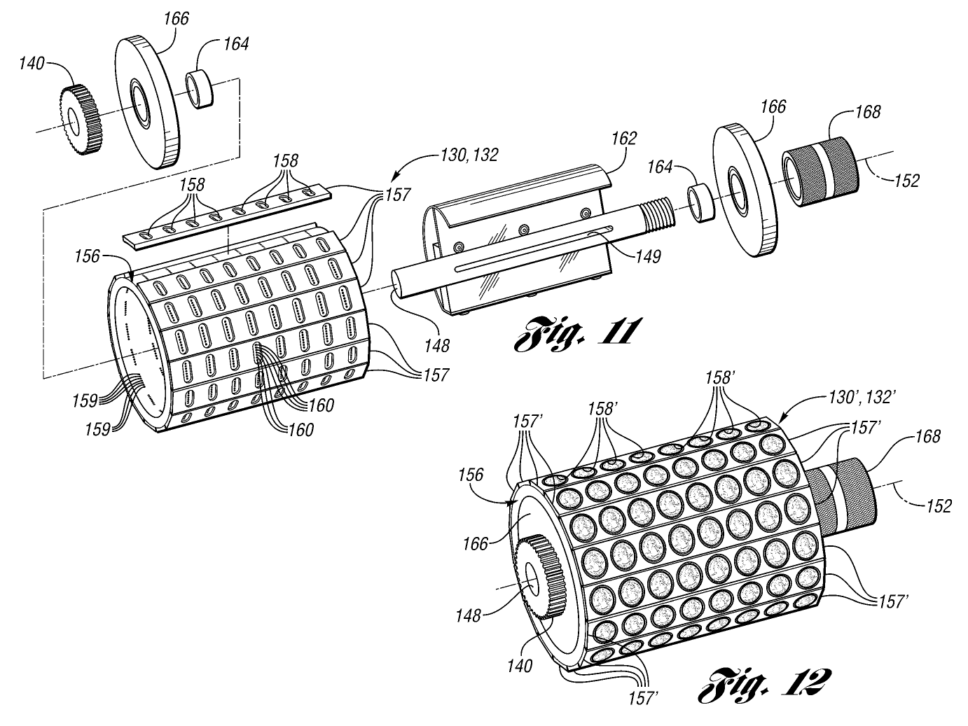

As further illustrated in FIG. 9, under control of the system controller, a drive for the conveyor 26′ operates to rotate the belt 29′ based on various sensor input signals from sensors to the system controller which, in turn, provides sequential control signals to the drive. The system controller also provides control signals to a computer display, object sorters (for example, air nozzles or jets 170 (FIG. 10) at the reject station) and to the first and second camera assemblies 110 and 112 at their respective vision stations.

Referring now to FIG. 11, each of the drums 130 and 132 includes a sprocket 140 by which a belt 136 drives the drums 130, 132 via a sprocket 138 of a motor assembly 134. The sprockets 140 are mounted on one of their respective spaced annular end plates 166 to rotate therewith with their respective cylinder members 156. The cylinder members 156 and end plates 166 are rotatably supported on their respective slotted, hollow shafts 148 by spaced bearing assemblies 164. A hollow vacuum coupler 168 is threadably secured at one end of the hollow shaft 148 opposite its sprocket 140 to communicate a vacuum from a vacuum source via a coupler 144 to the interior of its member 156 via the slot 149 formed through a side wall of the hollow shaft 148.

A stationary metal sheet 162 is secured to the shaft 148 and prevents the vacuum within the cylinder member 156 from communicating with certain holes 159 formed through the cylindrical side wall of the member 156, which, in turn, communicate with aligned holes 160 formed through strips 157 and into object receiving depressions 158 in the strips 157. The holes 159 blocked by the metal sheet 162 are those holes 159 which communicate with the empty depressions 158 of the drums 130 and 132 extending from their 6 o'clock position to their 12 o'clock position at which the drums 130 and 132 pick up more objects.

Objects are provided to the inspection machine subsystem by the feeder and the transfer subsystem at controlled regular and, preferably, equal intervals. The inspection machine subsystem includes several visual inspection stations, each of which includes an imaging assembly such as the camera assemblies 110 and 112 as shown in FIG. 9 located along the path of conveyance. As the objects are conveyed by the drums 130 and 132, the objects pass by the camera assemblies 110 and 112 of FIG. 9 at their respective visual inspection stations where the objects are imaged and inspected. Objects which pass each of the visual inspections (have no unacceptable defects) are accepted by being allowed to pass to the 6 o'clock or lowermost position of the drum 132 where there is an absence of vacuum at the outer surface of the drum 132 to fall into a “good object” bin located at the end of the path of conveyance below the drum 132. The “good object” may stay in the “good object” bin or fall further onto another conveyor 114 which is controllably driven by a drive by the system controller to one or more other inspection stations such as the eddy current station and/or the single-camera circumference vision station as previously described. As previously described, the inspection stations located throughout the inspection machine subsystem may include one or more of the following modular inspection stations: first and second vision (FIG. 9), eddy current (FIG. 7), and single-camera circumference vision (FIGS. 5-7).

Referring again to FIG. 9, the upper rotating drum 130 rotates an array of objects so that they travel along a circular path which extends from the 12 o'clock position of the drum 130 to a first inspection or vision station at which a row of the objects have a predetermined position but unknown orientation for machine vision inspection at a 9 o'clock position of the drum 130 for inspection by the first camera assembly 110. Subsequently, the vacuum transfer drum 130 of the transfer subsystem rotates the vacuum-held objects after inspection by the first camera assembly 110 so that the inspected objects travel along a circular path to a 6 o'clock position of the drum 130 for transfer (by the lack of vacuum acting upon the tablets in this position) to the lower rotating drum 132 at its 12 o'clock position. From the 12 o'clock position, the drum 132 rotates to its 9 o'clock position at the second vision station for further machine vision inspection by the second camera assembly 112. Finally, after inspection at the 9 o'clock position, the lower drum rotates the vacuum-held objects to the 7 o'clock position where any “defective” object is blown off the drum 132 by an air jet 170 (i.e. FIG. 10) at a rejection station. If an object is not defective, the object stays on the drum 132 until the 6 o'clock position of the drum 132 at which the objects are no longer held on the drum 132 by a vacuum.

As illustrated in FIGS. 11 and 12, the vacuum transfer drum 130 (for pills) and the drum 130′ (for coins) have a plurality of axially extending, apertured transfer strips 157 and 157′, respectively, bonded onto the outer surface of their respective cylindrical tube or members 155 or 155′, in which objects, such as tablets (in 8 columns in FIG. 11) or coins (in 8 columns in FIG. 12) are received and retained by vacuum in the depressions 158 and 158′, respectively. The depressions 158 in the strips 157 are spaced at intervals to provide a “metering effect” which allows the proper spacing of objects for inspection and rejection of defective objects. This enables optical inspection of the viewable top or bottom surfaces of the objects at the first and second vision stations by the camera assemblies 110 and 112. Typically, such vacuum transfer drums 130 and 130′ are capable of transferring small objects or articles between stations while maintaining a predetermined position and vertical orientation of the array of objects.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

1. A method of inspecting small, manufactured objects and sorting the inspected objects, each of the objects having top, bottom and side surfaces and an axis, the method comprising:
consecutively feeding and transferring the objects so that the objects travel along a path which extends from an object loading station and through a plurality of inspection stations including a first vision station wherein each object to be inspected at the first vision station has an unknown orientation and wherein only one of the top and bottom surfaces of each object is viewable at the first vision station;
imaging the viewable surface of each object at the first vision station to obtain a first set of images of the objects;
processing the first set of images with a top surface vision algorithm and a bottom surface vision algorithm to identify objects having unacceptable defects;
consecutively transferring objects from the first vision station to a second vision station, wherein each object to be inspected at the second vision has an orientation opposite the unknown orientation at the first vision station and wherein only the other one of the top and bottom surfaces of each object is viewable at the second vision station;
imaging the viewable surface of each object at the second vision station to obtain a second set of images of the objects;
processing the second set of images with the top surface vision algorithm and the bottom surface vision algorithm to identify objects having unacceptable defects; and
directing objects identified as having an unacceptable defect to at least one defective object area.

2. (canceled)

3. The method as claimed in claim 1 wherein the step of consecutively transferring from the first vision station to the second vision station includes the step of applying a vacuum to the objects to obtain the opposite orientation of each of the objects.

4. The method as claimed in claim 1 wherein the inspection stations include a third vision station and wherein side surfaces of each of the objects are viewable at the circumference third vision station.

5. The method as claimed in claim 4 further comprising:
simultaneously imaging the side surfaces of each object when the object is located at the third vision station to obtain a plurality of side images at a single image plane;
detecting the side images; and
processing the detected side images of each object with a side surface vision algorithm to identify objects having unacceptable defects.

6. (canceled)

7. (canceled)

8. The method as claimed in claim 1 wherein the objects are tablets, wherein the inspection stations include an eddy current station and wherein the method further comprises:
generating an electromagnetic signature of each tablet located at the eddy current station; and
processing the signatures to identify tablets having unacceptable defects in the form of metallic debris.

9. The method as claimed in claim 1 wherein at least one of the steps of imaging is performed with a three-dimensional sensor to obtain three-dimensional information about the imaged surface.

10. A system for inspecting small, manufactured objects and sorting the inspected objects, each of the objects having top, bottom and side surfaces and an axis, the system comprising:
a feeder and a transfer subsystem to consecutively feed and convey the objects so that the objects travel along a path which extends through a plurality of inspection stations including a first vision station wherein each object to be inspected at the first vision station has an unknown orientation and wherein only one of the top and bottom surfaces of each object is viewable at the first vision station;
a first imaging assembly to image the viewable surface of each object when the objects are located at the first vision station to obtain a first set of images of the objects;
at least one processor for processing the first set of images to identify objects having an unacceptable defect, the transfer subsystem consecutively conveying objects from the first vision station to a second vision station of the inspection stations wherein each object to be inspected at the second vision station has an orientation opposite the unknown orientation at the first vision station wherein only the other one of the top and bottom surfaces of each object is viewable at the second vision station;
a second imaging assembly to image the viewable surface of each object when the objects are located at the second vision station to obtain a second set of images of the objects;
at least one object sorter for directing objects identified as having an unacceptable defect to at least one defective object area; and
a system controller coupled to the transfer subsystem, each of the imaging assemblies, the at least one processor and the at least one object sorter for controlling the sorting based on the inspections.

11. (canceled)

12. The system as claimed in claim 10 wherein the subsystem includes a vacuum transfer conveyor including a perforated conveyor belt wherein a top or bottom surface of each of the objects is held against a surface of the belt to obtain the opposite orientation.

13. The system as claimed in claim 10 wherein the subsystem includes first and second vacuum transfer drums and a mechanism for synchronously rotating the drums, the first rotating drum conveying the objects at equal intervals to the first vision station and the second rotating drum conveying the objects supplied by the first drum at equal intervals to the second vision station.

14. The system as claimed in claim 10 further comprising a third imaging assembly wherein the inspection stations include a third vision station and wherein all of the side surfaces of each of the objects are simultaneously viewable at the third vision station by the third imaging assembly.

15. The system as claimed in claim 14 wherein the third imaging assembly includes:
a plurality of mirrors to simultaneously obtain a plurality of different views of the side surfaces of the object which are angularly spaced about the axis of the object when the object is located at the third vision station; and
a telecentric lens and detector assembly to simultaneously form an optical image of at least a portion of each of the views of the side surfaces of the object at a single image plane and to detect the optical images at the image plane, the at least one processor processing the detected optical images to inspect the object.

16. (canceled)

17. (canceled)

18. The system as claimed in claim 15 wherein the detector includes an image sensor having the image plane to detect the optical images.

19. (canceled)

20. The system as claimed in claim 10 wherein the objects are tablets, wherein the inspection stations include an eddy current station and wherein the system further comprises:
an eddy current subsystem for generating an electromagnetic signature of a tablet when the tablet is located at the eddy current station; and
a signature processor for processing the signatures to identify tablets having an unacceptable defect in the form of metallic debris.

21. The system as claimed in claim 10 wherein the first imaging assembly includes a three-dimensional sensor to obtain three-dimensional information about the viewable surface.

22. The system as claimed in claim 10 wherein the second imaging assembly includes a three-dimensional sensor to obtain three-dimensional information about the viewable surface.
